(19) United States
(12) Patent Application Publication
(10) Pub. No.: US 2026/0337827 A1
(43) Pub. Date: Oct. 29, 2026

(54) PROCESS TO MAKE AN ARAMID SOLUTION

(71) Applicant: TEIJIN ARAMID B.V., Arnhem (NL)

(72) Inventors: Wouter VIJSELAAR, Deventer (NL); Morena ALMA, Ede (NL); Bert GEBBEN, Velp (NL); René LA FAILLE, Zwolle (NL); Wido NIJENHUIS, Huissen (NL); Hanneke BOERSTOEL, Arnhem (NL); Said BOUDEBAH, Arnhem (NL); Kevin VAN ZITTEREN, Heijen (NL)

(73) Assignee: TEIJIN ARAMID B.V., Arnhem (NL)

(21) Appl. No.: 19/115,925

(22) PCT Filed: Oct. 9, 2023
(86) PCT No.: PCT/EP2023/077859

§ 371 Date: Mar. 27, 2025

(30) Foreign Application Priority Data
Oct. 11, 2022 (EP) 22200765.0

(51) Int. Cl. D01F 6/60; C08J 3/11; D01D 1/02; D01D 5/06; D01F 11/08; D02G 3/02

(52) U.S. Cl. CPC D01F 6/605; C08J 3/11; D01D 1/02; D01D 5/06; D01F 11/08; D02G 3/02; C08J 2377/10; D10B 2331/021

(57) ABSTRACT

The invention pertains to a process for manufacturing an aramid solution by combining components comprising a base, a proton donor, aramid and an aprotic solvent, wherein:-the base is dissolved in the proton donor to obtain a base solution,-the aprotic solvent and the aramid are combined to obtain an aramid-solvent mixture,-the base solution and the aramid-solvent mixture are combined to obtain a suspension, and-the suspension is mixed to obtain the aramid solution. Also claimed are a process to manufacture a continuous aramid fiber, a continuous aramid fiber, a process to manufacture aramid nanofiber and a material comprising the aramid nanofiber.

Instant invention pertains to a process to manufacture a solution of aramid, to processes to manufacture a continuous aramid fiber or an aramid nanofiber from the solution, and also to a continuous aramid fiber and to a material comprising the aramid nanofiber.

Processes to make solutions of aramid are known, in particular processes employing a strong base and an aprotic solvent, including proton-donor assisted dissolution processes.

In such processes aramid, in particular para-aramid is contacted with an alkaline, aprotic solvent (e.g. a KOH/DMSO system). In those instances, the hydroxide group reacts with a methyl group of the DMSO which results in formation of a dimsyl ion. The dimsyl ion is able to disrupt the hydrogen bonds in the aramid chain. The hydrogen bonds between a carbonyl group and a secondary amine (from the amide bond) from different polymer chains usually ensure the crystal structure of aramid fibers. The dimsyl ion creates a negative charge and the hydrogen bonds are disrupted. The negative charge will cause the polymer chains to repel each other and hence will cause the disintegration of the aramid, e.g. of aramid fibers.

CN112878036A discloses a method for preparing aramid nanofibers based on para-aramid deprotonation. The process includes: stirring and pretreating a mixed system of aramid fibers, an organic solvent and alkali to obtain an aramid fiber dispersion liquid; and adding a proton donor and/or an ionic reaction aid into the aramid fiber dispersion liquid to regulate and control the deprotonation degree so as to obtain an aramid nanofiber dispersion.

WO2021/070042A1 is directed to a process for the manufacture of a fiber comprising meta-aramid. A spin dope comprising meta-aramid polymer and sulfuric acid is prepared and passed through a spinneret into a coagulation bath, wherein the spin dope has a meta-aramid concentration of at least 10 wt %. The resulting meta-aramid fiber has a tenacity of at least 300 mN/tex and may have a high elongation at break of e.g. 49%. This application is not concerned with aramid nanofibers and para-aramid fibers.

U.S. Pat. No. 3,817,941 pertains to wholly aromatic carbocyclic polycarbonamide fibers having an initial modulus of at least 170 gpd and an orientation angle of up to 40°. These fibers, e.g. PPTA (poly(para-phenylene terephthalamide)) fibers, are spun from spin dopes based on the polymer and organic solvents, such as e.g. hexamethylphosphoramide and/or N-methyl pyrrolidone (NMP). As-spun fibers (prepared with the toxic solvent hexamethylphosphoramide) may have an elongation of 18 or 20%, but heat-treated fibers have an elongation of at most 5.4%. This application is not concerned with aramid nanofibers.

EP0309229A2 describes the preparation of isotropic and anisotropic polyamide anion solutions by using a base and sulfoxide solvents. In this way, aramid solutions with a concentration of 1.5 to 1.7 wt % may be prepared. By applying solvent evaporation or freeze drying, the aramid concentration of the solutions may be increased to up to 12 wt %. In the process, DMSO is added to a base and stirred. Subsequently, dry aramid pulp is added to the solvent-base mixture. The resulting solution may be used to spin aramid fibers. Such aramid fibers have an elongation in the range of 4.2 to 4.9%.

WO2017/117376A1 describes a process for making aramid nanofiber (ANF) wherein the aramid material is combined with a solution containing a base and an aprotic solvent. In various embodiments, the KOH/EtOK/DMSO-based reaction media can contain water. The aramid material and the base are present in relatively minor amounts in the solution. WO2017/117376A1 describes that the diameter of the nanofibers and the number of branches per nanofiber produced by the method can be controlled by adding water to the reaction. Relative to the amount of solvent, the concentration of aramid (e.g. 1%) and base is low. Dissolution times are generally in the order of days or weeks.

Cao et al. (Av. Funct. Mater., 2017, n. 27:1701061, DOI: 10.1002/adfm.201701061) is directed to carbon nanotube wires sheathed by ANF and describes that an ANF dispersion is prepared by adding potassium tert-butoxide and short-cut para-aramid fibers into DMSO. After initial stirring, methanol (as proton donor) was added in steps into the reaction. Dispersions with high aramid concentration (8 wt %) can be prepared in this way. Hollow fibers spun from the ANF dispersion seem to have an elongation at break (strain) of less than 3%. Similarly, Yang et al. (ACS Nano, 2019, 13, 7, p. 7886-7897, DOI: 10.1021/acsnano.9b02258) reports the proton donor-assisted deprotonation of para-aramid fibers to result in ANF in 4 hours (0.2 wt % aramid concentration). In this process, para-aramid fibers and KOH are added to DMSO. Subsequently, water is added to the system at different water to DMSO volume ratios.

H. Chen et al. (Green Chem., 2021, v23 n19: 7646-7658, DOI: 10.1039/d1gc01805a) also describes the proton donor-assisted making of aramid nanofibers. A KOH-water solution is made, which is added to the DMSO, and stirred to result in a KOH/H₂O/DMSO system. To this system the aramid material is added. Chen describes that the addition of aqueous KOH improves the solubility of the KOH in the DMSO and the dissolution of the aramid fibers. The dissolution time is short for 0.2 wt % aramid solutions (26 minutes) and 10 hours for 4 wt % aramid solutions.

Even though the prior art shows that the addition of proton donors to the dissolution system may decrease the time to dissolve the aramid in a system based on an aprotic solvent and a strong base, the dissolution times are still not suitable for industrial processes and further improvements are desired. In addition, continuous aramid fibers, in particular para-aramid fibers with a high elongation at break are desired, preferably with an elongation at break of at least 15% and more preferably with an elongation at break of at least 20%. Optimally, such fibers show a high elongation at break in combination with a great toughness.

These objects are realized with the instantly claimed process for manufacturing an aramid solution by combining components comprising a base, a proton donor, aramid and an aprotic solvent, wherein:
the base is dissolved in the proton donor to obtain a base solution,
the aprotic solvent and the aramid are combined to obtain an aramid-solvent mixture,
the base solution and the aramid-solvent mixture are combined to obtain a suspension, and
the suspension is mixed to obtain the aramid solution.

The aramid used to prepare the solution may include aramid fiber (including but not limited to continuous aramid fiber and non-continuous aramid fiber), aramid pulp, aramid film, aramid paper, aramid fibrids, aramid polymer particles (e.g. powder or crumbs) and any combination thereof. The aramid may include aramid obtained from recycling, thus based on end-of-life materials or production waste. Preferably, the aramid used as starting material comprises non-continuous aramid fiber. The non-continuous aramid fiber preferably has a length (or largest dimension) in the range of 0.1 mm to at most 100 cm, preferably at most 50 cm, more preferably at most 20 cm, even more preferably at most 10 cm, or up to 5 cm.

Fibers are to be understood as relatively flexible units of matter having a high ratio of length to width (across their cross-sectional area, perpendicular to their length).

In the context of this application the term “length” refers to the length weighted length (LL) for short fibers and the mean length for longer fibers. For short fibers (and pulp, fibrils and fibrids) up to a length of 6 mm the length weighted length may be determined by using the Pulp Expert™ FS (ex Metso), including particles with a length <250 micron.

For larger fibers (>6 mm) the length refers to the average fiber length by number (mean length, ML), which may be calculated by:

$$ML = \frac{{\sum }_{0}^{∞} n \cdot {L}_{n}}{N}$$

where n is the number of fibers of a certain length Lₙ, and N is the total number of fibers. The mean length may be determined with a fiber length distribution tester, such as a Classifiber (ex Kaisokki).

The aramid fibers may be in the form of short-cut.

Short-cut comprises short filaments and may e.g. be obtained by cutting continuous yarn, fabrics or woven materials.

In one embodiment the aramid short-cut fiber has a length in the range of 0.1 to 20 mm, preferably 1 to 10 mm, more preferably 3 to 8 mm.

Preferably, the aramid short-cut has a narrow length distribution.

In one embodiment, the length distribution of the aramid short-cut is such that at least 50 weight % of the filaments have a length which is within 30% of the length at a peak maximum in the length distribution curve. Preferably, at least 70 weight % of the filaments have a length which is within 30% of the length at a peak maximum in the length distribution curve.

The aramid short-cut fibers may be further treated before using them as starting material. For example, the aramid short-cut fibers may be grinded or milled.

The aramid may comprise pulp. Pulp consists of short fibers which have been subjected to a shearing force leading to the formation of fibrils, which are mostly connected to a “stem” of the original fiber, while thinner fibrils peel off from the thicker fibrils. These fibrils are curly and sometimes ribbon-like, and show variations in length and thickness.

In the context of the present specification aramid refers to an aromatic polyamide consisting of aromatic moieties directly connected to one another via amide fragments. Methods to synthesize aramids are known to those skilled in the art and typically involve the polycondensation of aromatic diamines with aromatic diacid halides. Aramids may exist in the meta- and para-form. Preferably, the aramid used as starting material for the process (preferably in the forms described above) is or consists of para-aramid.

Meta-aramids may be produced by polymerization of meta-type aromatic amine and meta-dicarboxylic acid halide.

Suitable aromatic meta-diamines are meta-phenylenediamine, 3,4′-diaminodiphenylether, and 3,4′-diaminodiphenylsulfone; and derivatives thereof having substituents such as halogen atoms and/or alkyl groups having 1 to 3 carbon atoms, attached to the aromatic cyclic structures thereof, for example, 2,4-toluylenediamine, 2,6-toluylenediamine, 2,4-diaminochlorobenzene, and 2,6-diaminochlorobenzene, may be employed. Preferably, meta-phenylene diamine or mixed diamines containing meta-phenylene diamine in a content of 85 molar % or more, more preferably 90 molar % or more, still more preferably 95 molar % or more are employed.

Suitable aromatic meta-dicarboxylic acid dihalides are isophthalic acid halides, for example, isophthalic acid chloride and isophthalic acid bromide; and derivatives thereof having substituents, for example halogen atoms and/or alkoxy groups having 1 to 3 carbon atoms, for example 3-chloroisophthalic acid chloride and 3-methoxyisophthalic acid chloride may be employed. Preferably, isophthalic acid chloride and mixed carboxylic acid halides containing isophthalic acid chloride in a content of 85 molar % or more, more preferably 90 molar % or more, still more preferably 95 molar % or more, are employed.

For the purpose of this application, the term para-aramid refers to a class of wholly aromatic polyamide polymers and copolymers having at least 60%, preferably at least 80% and more preferably at least 90% of para-oriented bonds between the aromatic moieties. In one embodiment, at least 95% or all (i.e. 100%) of the bonds are para-oriented bonds. Examples of the para-oriented aromatic diamine usable for producing the para-aramid of the present invention include para-phenylenediamine, 4,4′-diaminobiphenyl, 2,6-naphthalenediamine, 1,5-naphthalene-diamine, and 4,4′-diaminobenzanilide. To a maximum of 50 mole % substituted aromatic diamines can be used, such as 2-methyl-para-phenylenediamine and 2-chloro-para-phenylenediamine. Examples of para-oriented aromatic dicarboxylic acid halide usable for the present invention include terephthaloyl dichloride, 4,4′-benzoyl dichloride, 2,6-naphthalene-dicarboxylic acid dichloride, and 1,5-naphthalenedicarboxylic acid dichloride. Typical para-aramids are poly(para-phenylene terephthalamide) (PPTA), poly(4,4′-benzanilide terephthalamide), poly(para-phenylene-4,4′-biphenylene dicarboxamide), poly(para-phenylene-2,6-naphthalene dicarboxamide), 5,4′-diamino-2-phenylbenzimidazole, poly(para-phenylene-co-3,4′-oxidiphenylene terephthalamide) and copolymers thereof. Preferably, the aramid comprises or consists of poly(para-phenylene terephthalamide).

The solvent is an aprotic solvent, preferably a polar aprotic solvent.

In one embodiment the solvent is selected from dimethyl sulfoxide (DMSO), dimethyl formamide (DMF), dichloro methane (DCM), dimethyl acetamide (DMAc or DMA), tetramethyl urea or N-Methyl-2-pyrrolidone (NMP), or mixtures thereof. Even though DMAc, NMP and DMF are technically suitable solvents, it is preferred to use DMSO as solvent, which is neither considered carcinogenic, nor mutagenic nor reprotoxic.

The solvent is not sulfuric acid. Preferably, the solvent is free of alkali chloride salts and earth alkali chloride salts.

The base is preferably a strong base, preferably a base with a dissociation constant pKa (in water) of at least 10, more preferably a base with a dissociation constant pKa of at least 11. Such bases include for example oxides of alkali metals.

In one embodiment, potassium hydroxide (KOH), sodium hydroxide (NaOH), potassium ethoxide (EtOK), sodium hydride (NaH), potassium tert-butoxide (tBuOK), potassium hydride (KH) or sodium amide (NaNH₂) is used as base.

In one embodiment, DMSO as aprotic solvent and KOH as base are used.

The proton donor provides protons for the amide groups of the aramid polyanions that are formed. Such protons are needed to achieve nanofibers with an integrated molecular structure. Conventionally, the proton donor is added after the formation of the aramid solution to cause the structural restoration of the aramid nanofibers. However, a small amount of proton donor present during the forming of the solution may be advantageous. The proton donor may be selected from water and alcohol. The alcohol may be chosen from ethanol, methanol, isopropanol and ethylene glycol. The water may be demineralized water. Different proton donors may also be used in combination. It has been found that ethylene glycol is a suitable proton donor, in particular if the aramid solution is further processed into continuous aramid fibers. When preparing the aramid solution with ethylene glycol as proton donor, higher degrees of drawing may be applied during the spinning process which results in continuous aramid fibers with attractive mechanical properties.

In the process, a base solution and an aramid-solvent mixture are formed separately and then combined to result in a suspension.

The base solution is formed by combining an amount of base and an amount of proton donor and dissolving the base in the proton donor. The concentration of the base in the base solution may vary and may be in the range of 0.05 to 20 M. The concentration is chosen in dependence on the solubility of the base and in particular to realize a certain molar ratio of base to amide bond in the suspension obtained by combining the base solution and the aramid solvent mixture, as described below. The final concentration of the base in the suspension and the aramid solution is preferably below 2 M and more preferably below 1 M and may be below 0.5 M.

Preferably, the base solution is free of aprotic solvent, more preferably, the base solution consists of base and proton donor.

The aramid solvent mixture is formed by combining an amount of aramid and an amount of aprotic solvent. In the aramid solvent mixture the aramid and the solvent may form a slurry.

Preferably, the aramid solvent mixture is free of base and proton donor, more preferably, the aramid solvent mixture consists of aramid and aprotic solvent.

Subsequently, the base solution and the aramid solvent mixture are combined. This may be carried in different ways, e.g. by adding the base solution step-wise or at once to the aramid solvent mixture, or vice versa, or by adding both to a vessel suitable for mixing.

In one embodiment of the process, the weight ratio between the proton donor and the solvent is in the range of 1:5 to 1:1000, preferably in the range of 1:10 to 1:200, more preferably in the range of 1:20 to 1:100. For example, the weight ratio between the proton donor and the solvent may be in the range of 1:15 to 1:50, preferably a weight ratio of 1:25 is used. By adjusting the ratio between the proton donor and the solvent, the amount of proton donor present during the reaction relative to the amount of solvent may be adjusted. It was found that for the indicated weight ratios, in particular for the weight ratio of 1:15 to 1:40 the dissolution time is shorter and the amount of base (e.g. KOH) crystals observed by light microscopy in the aramid solution is much lower.

In one embodiment, the molar ratio of base to amide bond present in the suspension during the reaction is in the range of 10:1 to 1:10, preferably 5:1 to 1:5, more preferably 2:1 to 1:2, even more preferably 1.5:1 to 1:1.5. Preferably, the molar ratio of base to amide bond present in the suspension during the reaction is below 4:1, more preferably below 3:1. For example, if the aramid is PPTA, a repeat unit of the polymer including two amide bonds has a molecular weight of 238 g/mol. If PPTA as aramid and KOH as base (56 g/mol) are used, preferably equimolar amounts of base KOH per amide bonds in the aramid are used (and thus the weight ratio between base and aramid is lower than 1). The molar ratio of base to amide bond is preferably 2:1 to 1:2, even more preferably 1.5:1 to 1:1.5 and most preferable an equimolar ratio is applied, also when higher concentrations of aramid are used, i.e. where the concentration of aramid in the final aramid solution is above 3 wt %.

This is different from e.g. WO2017/117376A1 which may apply the base in stoichiometric excess to the aramid, but conveniently in a one-to-one weight ratio, but only at lower aramid concentrations. Chen at al. increases the amount of base when higher aramid concentrations are desired, e.g. to a molar ratio of base to amide bond of 3:1. Using a nearly equimolar ratio of base to amide bonds in the aramid, in particular for highly concentrated aramid solutions, is advantageous for the disintegration of the aramid, the reaction speed and to avoid the presence of an excess of base crystals.

By separately preparing the base solution and the aramid solvent mixture and only combining these ingredients subsequently, the disintegration and dissolution process of the aramid polymer is improved and the dissolution time (which may also be referred to as reaction time) is shortened. In particular it is advantageous to add the base solution to the aprotic solvent already containing the aramid since this seems to reduce the crystallization of base particles which occurs more frequently when the base solution is added to a solvent and only thereafter the aramid is added.

In one embodiment, the suspension is subjected to shearing, preferably strong shearing, to improve, in particular accelerating, the disintegration and subsequent dissolution of the aramid. This may improve the dissolution of the aramid. Shearing may be applied by rigorous stirring, kneading or sonicating the composition. Sonication may be used at a frequency in the range of 10 to 50 kHz, preferably 15 to 25 KHz.

The dissolution of the aramid preferably takes place at room temperature or increased temperature, but below 75 °C. Preferably, the reaction takes places at a temperature in the range from room temperature to 65 °C, more preferably from room temperature to 60 °C, to avoid (hydrolytic) degradation of the polymer. Preferably, the dissolution of the aramid material takes place at a temperature of at least 15 °C, preferably at least 18 °C. Reaction temperatures of 40 °C and 60 °C were found to result in aramid solutions without particles and crystals, in particular being free of base crystals.

In one embodiment, at least the mixing step takes place in a high-shear mixer or speed mixer, e.g. in a twin shaft kneader or a twin screw extruder, or a twin screw kneader or mixer, a single screw kneader or single screw extruder or a Drais mixer. Preferably, also the step of combining the base solution and the aramid-solvent mixture takes place in such high-shear mixer. More in particular, both steps take place in the same high-shear mixer, preferably in the identical twin screw kneader or twin screw extruder.

In particular for large-scale processes, it has been found that the use of such equipment is advantageous to create sufficient shear, use shorter mixing time and to enable a continuous process.

For an industrial scale process, the following embodiment of the process may be used. The amount of base is dissolved in the proton donor in a vessel to obtain the base solution. The aprotic solvent and the aramid are added into a high-shear mixer (concomitantly or subsequently, if subsequently, preferably first the aramid polymer should be added to the high-shear mixer), e.g. a twin screw extruder, and mixed to prepare the aramid-solvent mixture. Subsequently, the base solution is added into the high-shear mixer. The high shear mixer, e.g. a twin screw extruder, may have separate inlets for the addition of the base solution and the aramid-solvent mixture or the polymer and solvent in the event of separate dosing. Preferably, the inlet for the base solution is downstream of the inlet for the aramid and the aprotic solvent. The base solution may be injected (e.g. under high pressure) and combined with the aramid-solvent mixture. The amount of aramid should be adjusted to result in a final polymer concentration of at least 5 wt %, preferably 7-20 wt %, more preferably 10-20 wt %, even more preferably 12-18 wt %. The processing in the high-shear mixer, e.g. a twin screw extruder, should preferably take place at a temperature in the range of 15 to 70 °C, preferably at most 65 °C, more preferably at most 60 °C (if necessary, cooling may be applied). By adjusting the feeding dosage and the outlet stream (the extrudate), the mixing time is adjusted. To achieve high shear, rotation speeds of up to e.g. 300 rpm may be used. The screw configuration of the extruder can be constructed with a number of different elements such as transporting, mixing, and kneading elements.

The following screw configuration may preferably be used: the entering zone element has preferably a length of 3-6 D (D stands for diameter of the screw in mm) and can have a length as large as 6 to 9 D and is equipped with transport elements which are single or double flighted. The single and double flighted elements are well known conveying elements which do not cause compaction during conveying. The mixing and dissolution zones may have a length of 15 to 30 D, and preferably of 20-23 D, using elements without transport character (screw elements such as W&P Igel or Hedgehog and/or single/multi row tooth mixing ZME; Berstorff single or multi row tooth mixing ZB, and Clextral multi row tooth mixing BMEL) or having interrupted transport character (screw elements such as W&P type SME or Berstorff type EAZ-ME). The mixing elements without transport character are characterized in that they do not cause conveying and that they are therefore totally filled-up with product, having dispersive mixing character. The mixing elements with interrupted transporting character have a channel with conveying character. These elements have distributive mixing character and are not necessary totally filled-up. Alternatively, the following screw configuration may be used: the entering zone element has a length of 2-10 D preferably 5-7 D (D stands for diameter of the screw in mm). The mixing and dissolution zones may have a length of 10 to 20 D, and preferably of 13-16 D, using elements with transport character. The degassing zone may have a length of 3-8 D and preferably 2-4 D using negative transport elements as vacuum loc and positive transport elements at the vacuum connection of the (twin screw) extruder. The mixing and compression zones may have a length of 10 to 30 D, and preferably of 16-19 D, using elements with transport or compression character.

Optionally, a vacuum (underpressure) can be applied in the extruder, to remove any gases and to obtain a gas-free aramid solution suitable for further processing.

Optionally, large undissolved particles, e.g. base particles having a size of more than 0.5 μm, may be removed prior to injection of the base solution into the high-shear mixer (e.g. by sedimentation, decantation or filtration).

An advantage of the instant process is the short time to obtain an aramid solution. The mixing step to obtain the aramid solution preferably takes 3 minutes to 2 hours, depending on the choice of the mixing device, also for aramid concentrations of above 3 wt % or even above 5 wt %. Since the base is easily dissolved in the proton donor, the step to prepare the base solution is very short and also the step of combining the aprotic solvent and the aramid is very short, in particular when using a high-shear mixer.

The dissolution or reaction time indicates the time at which-after mixing of the base solution and the aramid solvent mixture—no aramid particles are visible when observing the solution in a light microscope (with crossed polarization filters at 5× magnification).

Preferably, the aramid concentration in the aramid solution is in the range of 1 to 20 wt %, preferably 2 to 18 wt %, more preferably 4 to 15 wt %. Preferably, these concentrations are achieved by dissolving the aramid starting material to this concentration, without first making a solution with a lower concentration and subsequently removing the solvent. Preferably, the aramid solution shows optical anisotropy (liquid crystalline behavior), i.e. the aramid molecules are closely packed and adapt an ordered arrangement.

The optical anisotropy of the solution may be examined under a polarization microscope (crossed polarizers, bright image) and/or seen as opalescence during stirring.

Usually, aramid solutions—based on an aprotic solvent and a base—comprising at least 3 wt % of aramid (at room temperature) will show optical anisotropy. Aramid solutions with higher concentrations (e.g. at least 4 wt %, at least 5 wt % or at least 10 wt %) will show optical anisotropy. Optical anisotropy may also be referred to as birefringence. Solutions with high concentrations of aramid are easier and more efficiently processed subsequently into shaped articles (e.g. continuous fibers, aramid nanofibers, films or coatings). Also, lower amounts of solvents are used and occur as waste or are needed to be recovered.

Hence, the process of instant invention provides a very quick process to produce aramid solutions with high aramid concentrations which can be processed in a number of ways and result in products with attractive properties.

The present invention also pertains to processes to process the aramid solution into various shaped articles or materials, such as continuous aramid fiber, aramid nanofiber, an aramid film or coatings or composites comprising aramid.

In particular, the present invention pertains to a process to manufacture a continuous aramid fiber, comprising:
i) providing the aramid solution produced according to any of the embodiments of the process,
ii) passing the solution through a spinneret,
iii) coagulating the solution to result in a fiber, and
iv) washing the fiber.

Preferably, the process to manufacture a continuous aramid fiber spinning process is a dry-jet wet spinning process. This means, that the solution is passed through a gaseous medium after exiting the spinneret and before entering the coagulation bath. Preferably, the solution passes through a gaseous medium. The gaseous non-coagulating medium preferably consists of air.

The gaseous medium (also referred to as air gap) preferably has a length in the range of 2 to 20 mm, more preferably 3 to 15 mm and even more preferably of 5 to 10 mm. In the gaseous medium through which the solution passes, the aramid present in the solution is drawn. However, it is also possible to process the solution into continuous fibers in a wet spinning process without using an airgap and thus after leaving the spinneret, the solution directly passes into the coagulation bath.

The degree of drawing, that is the ratio between the length of the filaments upon leaving the coagulation bath and the average length of the solution upon leaving the spinning orifices of the spinneret, may be in the range of 1.5 to 15, preferably 2 to 6. The drawing of the fiber in the airgap increases the molecular alignment in the fiber, increases the mechanical properties and reduces the diameter of the fiber (in the case of a multifilament yarn, this occurs at filament level).

After coagulation, the continuous aramid fibers formed are usually removed from the coagulation bath, washed, dried and taken up on a bobbin (in any order). Optionally, after passage through the coagulation bath and/or after washing, the continuous aramid fibers are neutralized, e.g. by subjecting them to an acidic solution (e.g. by spraying or passing the fibers through a bath). The optional drying step may occur after washing and/or neutralization and before winding. In another embodiment, the wet continuous aramid fibers are wound on a bobbin and subsequently washed and/or dried. The spinnerets that are used may be of a type known in itself for dry jet-wet spinning.

Surprisingly, it has been found that spinning of the aramid solution, in particular spinning into low linear density filaments (e.g. 0.5 to 10 dtex/filament, preferably 1 to 6 dtex/filament or 1 to 3 dtex/filament), and subsequent washing of the filaments, allows the efficient removal of the base.

If para-aramid polymer that has not been processed or shaped previously is used as aramid starting material to make the solution, the continuous para-aramid fiber obtained by this process is free of sulfonic acid groups.

Alternatively, if the aramid comprises recycled para-aramid, the continuous para-aramid fiber obtained by this process may comprise sulfonic acid groups (if the para-aramid had previously been processed in sulfuric acid).

Continuous aramid fibers produced in this way, i.e. based on the aramid solution as described above, may have attractive mechanical properties, e.g. they may show less fibrillation (higher abrasion resistance), have a high elongation at break and/or a high resistance to transverse compression.

Preferably, continuous para-aramid fibers (e.g. as obtained by the process) have an elongation at break of at least 15%, more preferably at least 20%, even more preferably of at least 25% or even at least 30%. Preferably, the continuous para-aramid fibers (e.g. as obtained by the process) have a toughness at rupture of at least 40 J/g, more preferably of at least 50 J/g, even more preferably of at least 60 J/g.

Thus, the current invention also relates to continuous para-aramid fibers having a high elongation at break and high toughness at rupture.

The continuous para-aramid fibers produced by the process preferably combine a high elongation at break with a high toughness at rupture. In one embodiment, the continuous para-aramid fibers have an elongation at break of at least 15%, more preferably of at least 20% and a toughness at rupture of at least 40 J/g, preferably at least 45 J/g. The elongation at break and the toughness at rupture are determined on filament level according to ASTM D3822 after conditioning at 20 °C and 65% relative humidity and using a testing speed of 50 mm/min and a gauge length of 100 mm.

The toughness at rupture is also referred to as toughness, breaking toughness or fracture toughness. Toughness is the ability of the fiber to resist breaking under stress. The toughness is the area under the stress-strain curve.

Preferably, the continuous para-aramid fiber, has a breaking tenacity of at least 150 mN/tex, preferably at least 200 mN/tex and more preferably of at least 250 mN/tex, determined according to ASTM D3822-14 after conditioning at 20 °C and 65% relative humidity and using a testing speed of 50 mm/min and a gauge length of 100 mm.

Preferably, the continuous para-aramid fiber comprises at most 10 wt %, even more preferably at most 5 wt % or even at most 2 wt % of a polymer other than para-aramid.

More preferably, the continuous aramid fiber comprises or consists of para-aramid, preferably poly-p-phenylene terephthalamide.

Continuous para-aramid fibers, with such high elongation at break and with such high toughness cannot be produced with conventional spinning technology, where para-aramid is dissolved in sulfuric acid or where para-aramid is dissolved in conventional organic solvents (such as hexamethylphosphoramide, N,N-DMAc and/or N-methyl pyrrolidone in combination with salts such as LiCl or CaCl₂)) without deprotonation. Such continuous para-aramid fibers are particularly suitable for application in tires and hoses, as e.g. vehicle tires and turbo charger hoses.

The continuous para-aramid fiber differs in its crystal structure from conventionally produced para-aramid fibers obtained by dissolving para-aramid polymer in sulfuric acid or conventional organic solvents and processing this spin dope by dry-jet wet spinning. In particular, the continuous para-aramid fiber produced by instant process-even though subjected to similar spinning conditions-seems to result in less oriented and aligned polymer crystallites in the fiber.

A further difference between the continuous para-aramid fibers described herein and para-aramid fibers produced conventionally by dissolving the para-aramid polymer in organic solvents or sulfuric acid is the morphology and surface structure of the fiber. In one embodiment, the continuous para-aramid fibers have parallel nanofiber structures on at least part of the surface which may be observed with microscopy, in particular with scanning electron microscopy (SEM).

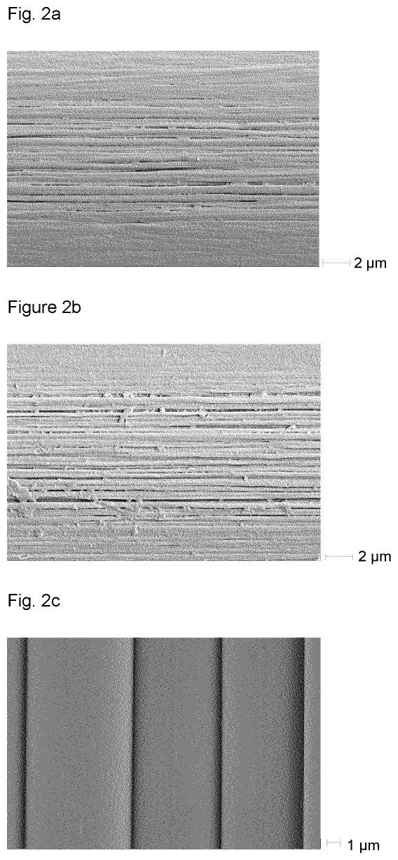

FIGS. 2a and 2b show SEM images of two examples of the continuous para-aramid fibers according to the invention and FIG. 2c shows a SEM image of conventionally produced para-aramid fibers (Twaron®, spun from sulfuric acid).

It is likely that the parallel nanofiber structures visible on the continuous para-aramid fiber according to the convention are due to the fact that the aramid solution that is used for spinning the continuous aramid fibers comprises deprotonated para-aramid and hence still larger molecule structures than present in the spin dopes where para-aramid was dissolved in sulfuric acid or organic solvents without deprotonation.

In one embodiment, the continuous para-aramid fiber has an oriented crystallite fraction of less than 40%, preferably less than 35%, more preferably in the range of 20 to 30%, even more preferably in the range of 25 to 30%.

In one embodiment, the continuous para-aramid fiber is characterized by an orientation parameter OA in the range of 40 to 60°, preferably in the range of 42 to 57°, more preferably in the range of 48 to 55°.

In one embodiment, the continuous para-aramid fiber has a lateral crystallite size L200 below 40 Å, preferably in the range of 30 to 38 Å.

Conventionally produced para-aramid yarn, as for example available under the trademark TWARON®, generally has an oriented crystallite fraction of above 90%, usually almost 100%, an orientation parameter OA of below 30°, preferably between 5 and 20° and a lateral crystallite size L200 above 50 Å, usually in the range of 50 to 80 Å.

The oriented crystallite fraction, the orientation parameter and the lateral crystallite size L200 are determined by X-ray diffraction (XRD), as detailed further in the experimental section.

The continuous aramid fiber may be a multifilament yarn.

In another embodiment, the fiber may be a nanofilament, having a diameter in the nanometer range.

Preferably, the continuous para-aramid fiber has a high relative viscosity ηᵣₑₗ, i.e. the para-aramid polymer has a high molecular weight. Preferably, the continuous para-aramid fiber has a relative viscosity ηᵣₑₗ in the range of 3 to 8, preferably in the range of 3.5 to 6, more preferably in the range of 4 to 5.5 as determined with a viscometer.

The relative viscosity is determined by dissolving a fiber sample in sulfuric acid at room temperature. The flow time of the sample solution in sulfuric acid 96% (0.25% mass/volume) is measured at 25 °C in an Ubbelohde viscometer. Under identical conditions the flow time of the 96% sulfuric acid is measured as well. The relative viscosity is then calculated as the ratio between the two observed flow times.

The relative viscosity ηᵣₑₗ is different from the inherent viscosity as described in the prior art. The inherent viscosity is the ratio between In (ηᵣₑₗ) (the natural logarithm of a relative viscosity) and C, where C represents a concentration of 0.5 gram of para-aramid polymer in 100 ml solvent.

The relative viscosity as basis for this calculation is determined by dividing the flow time in a capillary viscometer of a dilute solution of the polymer by the flow time for the pure solvent. However, in this case (as for example described U.S. Pat. No. 3,817,941) the dilute solutions used for determining the relative viscosity are of the concentration expressed by (C) above (i.e. 0.5 g/100 ml); flow times are determined at 30 °C, using concentrated (95-98%) sulfuric acid as a solvent.

For example, an inherent viscosity of 1.13 corresponds to a relative viscosity of 1.34, an inherent viscosity of 2.56 corresponds to a relative viscosity of 1.97 and an inherent viscosity of 4.00 corresponds to a relative viscosity of 3.00, an inherent viscosity of 4.97 corresponds to a relative viscosity of 3.98, an inherent viscosity of 5.73 corresponds to a relative viscosity of 4.99, an inherent viscosity of 6.35 corresponds to a relative viscosity of 6.01 and an inherent viscosity of 6.87 corresponds to a relative viscosity of 7.03. A fiber with a high relative viscosity has improved mechanical properties.

Preferably, the continuous para-aramid fiber is manufactured by using the aramid solution as described above in a spin process as described above. However, the invention is not limited in this regard.

In a preferred embodiment, the continuous para-aramid fiber has a content of carcinogenic, mutagenic and reprotoxic organic solvents below 250 ppm, preferably below 100 ppm, more preferably below 50 ppm, corresponding to a content of below 0.025 wt % (based on the weight of the fiber), preferably below 0.01 wt %, more preferably below 0.005 wt %. This means that the combined content of carcinogenic and reprotoxic organic solvents, in particular NMP (N-methyl pyrrolidone), DMF (dimethylformamide), DMAc (dimethyl acetamide) and HMPA (hexamethylphosphoramide), is below 250 ppm, preferably below 100 ppm and more preferably below 50 ppm.

The organic solvent content may be determined by different methods, depending on the specific organic solvent. Generally, gas chromatography (GC), NMR (nuclear magnetic resonance) and MS (mass spectrometry) are suitable to determine the organic solvent content, e.g. the NMP or DMAc content, of the fibers. In the context of the current invention, the organic solvent content is determined by gas chromatography. About 10 mg of fiber is collected and heated over 500 °C in an electric furnace. Gas chromatography (Shimadzu Corporation, Ltd., Model: GC-2010) was used to measure the amide solvent amount vaporized from the fiber. Subsequently, residual solvent concentration in the fiber was calculated by using the calibration curve prepared by using an amide-based solvent as a standard sample.

Another object of present invention is a process to manufacture aramid nanofiber, comprising:
i) providing the solution produced according to any of the embodiments of the process, and
ii) adding an amount of a proton donor to the solution.

The proton donor may e.g. be the same proton donor as used for the process to manufacture the aramid solution or a different one. Preferably, the added proton donor is water. Alternatively, another coagulant may be used instead of a proton donor, such as e.g. ketones (e.g. acetone or methyl ethyl ketone).

After precipitation of the aramid nanofiber, the aprotic solvent may be removed, e.g. by washing with water and/or evaporation.

The aramid nanofiber obtained by this process may be used for coating various substrates, in particular to amend or improve the substrate properties or at least the surface properties of the substrate. For example, a coating of aramid nanofibers may be used to improve the fire resistance of a substrate.

Further, the aramid nanofiber may be used for the reinforcement of composite materials, in particular aramid nanofiber may be added to the resin or matrix material of the composite.

Alternatively, the aramid nanofiber may be used as filler material (e.g. in sheet-like materials such as papers or in composites) or as adhesive.

Hence, instant application is also directed to a material comprising the aramid nanofiber, said material preferably being selected from a coating and a composite.

Another object of present invention is a process to manufacture an aramid film, comprising:
i) providing the solution produced according to any of the embodiments of the process,
ii) supplying the solution on a surface, and
iii) solidifying the solution to form a film.

In one embodiment, the solution may be combined with a solution of another polymer prior to supplying the solution on a surface. The combined solution may be used to manufacture an aramid film comprising another polymer.

The surface may be a support surface. Alternatively, the surface is part of an object which is to be coated with a film of the solution.

The solution may be supplied to the (support) surface by casting, e.g. from a die, or application with a roller.

Alternatively, an object which is to be coated with a film of the solution is dipped into the solution or coated by other methods, including spraying or other well-known methods. Subsequently, the solution is solidified to form a film. This may be realized by drying or by coagulation. For coagulation, the solution is subjected to an aqueous coagulant, e.g. water or an aqueous solution of the solvent.

Preferably, the film is rinsed or washed to remove residual solvent and/or base. The aprotic solvent and base may be removed, e.g. by washing with water and/or evaporation. The washed film may be subjected to drawing and drying. Optionally, the dried film may be heat-treated.

The solution may also be used to manufacture a resin composite. The solution may be combined with a resin or added to a resin solution (e.g. comprising epoxy resin) to improve the mechanical properties of the resin after it has been hardened.

Hence, this application also pertains to the aramid nanofiber, the aramid film and the continuous aramid fiber obtained by any of the processes for processing the aramid solution. Further, the application pertains to materials comprising the aramid nanofiber obtained by the above described process. The material may be selected from a coating and a composite.

The invention is further illustrated by the following, non-limiting examples.

### Methods

1. X-Ray Diffraction (XRD)
a) Sample Preparation

A small bundle of yarn is wound on a sample holder (thickness sample holder is 0.55 mm), about 0,03 g yarn/cm² is required. The filaments are wound on the sample holder parallel to each other.

### b) Determination of Lateral Crystallite Sizes L110 and L200 Via 1D Wide Angle X-Ray Scattering (WAXS)

### i) Measurement Conditions

XRD measurements are carried out using a Bruker D8 Advance diffractometer in θ/2θ geometry, equipped with parallel beam optics and point detector (scintillation counter). The optics consists of a primary 60 mm Göbel focusing mirror (a parabolic Ni/C multilayer device) providing Cu-Kα radiation (Kα1/Kα2 doublet, Ka wavelength=1.5418 Å), and 0.12° parallel beam attachment (i.e. Soller slits parallel to the goniometer axis). Generator settings: 40 kV, 40 mA.

The sample is measured in reflection mode while rotating (15 rpm). The measurement is done from 2θ=3° to 50°, step size (2θ)=0.02° and time/step=4 seconds.

### ii) Calculations

Lateral crystallite sizes L110 and L200 are determined with Bruker TOPAS P, version 4.1 software, using a 4-peak fit model with a linear background. The model consists of 2 split Pearson VII (SPVII) peaks in the 2θ range 12-35° at positions 2θ=20.5° and 22.8° and 2 Pearson VII (PVII) peaks at positions 2θ=18.5 and 28.4 (note: SPVII is an asymmetric profile function, PVII is a symmetric profile function).

The crystallite sizes are calculated according to Scherrer's formula with Scherrer constant k=1 and nominal instrumental correction (β correction) of 0.1°.

### c) Determination of the Oriented Crystallite Fraction f and the Orientation Parameter OA Via 2D WAXS Measurement of the 200 Reflection

### i) Measurement Conditions

XRD measurements are carried out using a Bruker D8 Discover X-ray diffractometer. This instrument is based on a horizontal two circle goniometer and is equipped with Montel optics, an XYZ translation stage and Vantec-500 area detector. The X-ray source is a 2.2 kW Cu anode long fine focus ceramic X-ray tube (type KFL CU 2K90). The Montel optics (Montel-P, 6 cm long) consists of a pair of Göbel Mirrors (a parabolic Ni/C multilayer device) arranged side by side with a 90° angle to each other, producing a highly parallel beam. The divergence of the primary X-ray beam is limited to <0.07° in both directions. The sample to detector distance is 8.2 cm, as determined using a corundum standard sample. Generator settings: 40 kV, 40 mA.

The sample is mounted on the goniometer such that the highest intensity of the 200 peak is at azimuthal angle Phi=90±10°.

The samples are measured on-axis (i.e. primary beam perpendicular to the detector) for 30 minutes. The 2D XRD patterns are corrected for non-uniformity and spatial distortion using standard GADDS procedures (i.e. flood field correction and unwarping), the patterns are also corrected for air scattering.

### ii) Data Treatment

The 2θ (max) position of the maximum of the 200 peak is determined via Bruker GADDS software, version 4.1.44.

The azimuthal curve of the 200 reflection is determined by 2θ integration of the 2D domain in the 2θ range between 2θ (max)−0.5° and 2θ (max)+0.5° (i.e. the integration domain has a width of 1° in 20). This integration results in a 1D Phi curve from 0 to 180°.

iii) Calculation

A sample consists of an oriented crystallite fraction f with orientation parameter OA and an unoriented crystallite fraction (1-f). The parameters f and OA of a sample are determined as follows:

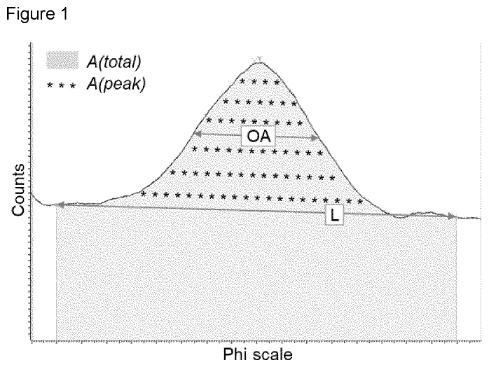

fraction f[%]=100×(A(peak)[cps×degrees])/(A(total)[cps×degrees])OA[°]=FWHM[°],

wherein the total area A (total) under the azimuthal curve (raw area, unit: cps x degrees), the area of the peak A (peak) (net area, unit: cps x degrees) and the full width half maximum (FWHM) of the peak (unit: degrees) in the azimuthal phi range 10°-170° with linear background line L are determined from the smoothed azimuthal curve using Bruker EVA software, version 14.0. FIG. 1 is an example of a determination and indicates the orientation parameter OA, the background line L, the peak area (peak) and the total area (total).

### 2. Mechanical Fiber Properties

The elongation at break, the toughness at rupture and the breaking tenacity of the fibers are determined on filament level according to ASTM D3822-14 after conditioning at 20 °C and 65% relative humidity and using a testing speed of 50 mm/min and a gauge length of 100 mm.

### 3. Turbidity

A HACH 2100Q is portable turbiditymeter was used according to the instructions of the manufacturer: the apparatus was first calibrated with calibration samples of the manufacturer, and subsequently a glass cuvette comprising the solution sample was placed in the apparatus, and after 10 seconds the turbidity (determined in Nephelometric Turbidity Units, NTU) was determined. The glass cuvettes with the samples were placed into an vacuum stove (50 mbar for 10 minutes at room temperature) prior to measurements to remove air bubbles.

### 4. Microscopy

Samples of the suspension or aramid solution were studied with a light microscope with polarization filters (ex Leica) to determine the presence of base crystals and/or aramid particles and anisotropic/isotropic behavior. For increasing the contrast of the image (in particular for determining the anisotropic or isotropic behavior of a sample), the polarization filters are crossed.

### 5. Scanning Electron Microscopy (SEM)

Preparations of the samples were made on a 6 cm×10 cm brass plate. Images of the samples were recorded by SEM (Zeiss Sigma VP), using an SE2 detector and the following settings:

| EHT parameter | 5 | kV |
|---|---|---|
| Detector | SE2 | |
| Aperture | 120 | μm |
| Sputter Coater | 208HR High Resolution | |
| Coating | Pt/Pd | |
| Supplied current | 40 | mA |
| Timer | 60 | s |

### EXAMPLE 1

Two para-aramid solutions were prepared having a concentration of 5 wt % and based on either PPTA short cut fiber or PPTA polymer powder (the PPTA polymer powder having an relative viscosity of >5). The respective amount of PPTA was weighed and combined with DMSO to result in the aramid solvent mixture. In parallel, a solution of KOH in water was prepared. The base solution was added to the aramid solvent mixture at a weight ratio of water to DMSO of 1:25, resulting in a final KOH concentration in the suspension of 0.49 M, and mixed in a speed mixer until complete dissolution of the aramid (4 min for powder, 8 min for short cut fiber). The molar ratio of KOH per amide bond was 1. The solutions were further liquified using a speedmixer (DAC150) and transferred to a spinning tube. The spinning was carried out at a temperature of 60 °C using a spinneret having 6 holes with each a diameter of 300 μm. The solution was pressed through a filter and thereafter through the spinneret. The filaments were passed through an air gap and coagulated in a water bath, wound up under tension on a bobbin, washed and dried. By varying the winding tension, different degrees of drawing were realized (where the degree of drawing is the ratio between the final length after drawing and the length before drawing).

Table 1 shows the sample information of the yarns.

TABLE 1

| Sample | Para-aramid material | Degree of drawing |
|---|---|---|
| 1-1 | PPTA short cut fiber | 1.67 |
| 1-2 | PPTA short cut fiber | 2 |
| 1-3 | PPTA polymer powder | 1.67 |
| 1-4 | PPTA polymer powder | 3 |
| 1-5 | PPTA polymer powder | 2 |

Subsequently, the mechanical properties of the filaments were determined, the results of which are shown in Table 2, and the crystallite properties of sample 1-1 and 1-5 were analyzed with X-ray diffraction (Table 3).

TABLE 2
mechanical properties of the filaments

| Sample | LD (dtex) | BT (mN/tex) | EAB (%) | ToaR (J/g) |
|---|---|---|---|---|
| 1-1 | 19.8 | 209 | 33 | 51 |
| 1-2 | 14.5 | 251 | 43 | 76 |
| 1-3 | 19.5 | 250 | 47 | 90 |
| 1-4 | 10.9 | 260 | 39 | 74 |
| 1-5 | 16.9 | 247 | 46 | 81 |

LD = linear density,
BT = breaking tenacity,
EAB = elongation at break,
ToaR = toughness

TABLE 3
XRD results

| | Orientation | Oriented | | |
|---|---|---|---|---|
| | parameter OA | crystallite | | |
| Sample | (°) | fraction (%) | L110 (Å) | L200 (Å) |
| 1-1 | 48 | 26 | 29 | 33 |
| 1-5 | 55 | 29 | 28 | 32 |

As shown by the examples, instant process allows the quick preparation of a spinnable aramid solution. The fibers obtained after spinning have a high elongation at break in combination with a high toughness. The fibers contain a relatively low oriented crystallite fraction, indicating a lower crystallinity and a lower degree of orientation. This combination of properties cannot be realized by conventional spinning of para-aramid from sulfuric acid spin dopes. In contrast, conventionally obtained para-aramid yarns (i.e. by spinning from sulfuric acid) have a much higher crystallinity and the crystallites are arranged very orderly in the fiber.

Samples 1-1 and 1-5 have been analysed by scanning electron microscopy (SEM). FIG. 2 shows the images of both samples (FIGS. 2a and 2b). Both samples clearly show the nanofiber structure at parts of the surface. FIG. 2c shows a SEM image of a prior art para-aramid fiber spun from sulfuric acid. No nanofiber structure is visible on this fiber surface.

### Example 2

Aramid solutions were prepared in the same way as described for example 1, but using an amount of either PPTA short cut fiber or PPTA polymer powder to result in a solution having a para-aramid concentration of 3 wt %. The base solution was added to the aramid solvent mixture at a weight ratio of proton donor H₂O to solvent DMSO of 1:25 for all samples.

The amount of KOH was varied to result in a final concentration in the solution varying between 0.28 to 1 M, as indicated below. For the samples using 0.28 M KOH, the molar ratio between base KOH and amide bond in the aramid material is 1:1. The solutions were prepared using either a stirrer at increased temperature (samples 2-1 to 2-4) or using a speedmixer (samples 2-5 and 2-6) in which an increased temperature is generated through shearing. In the speedmixer, rotation speeds of 3500 rpm (2×90 seconds at 3500 rpm, 1×45 seconds at 3500 rpm, sample 2-5) or increasing rotation speeds (2×30 seconds at 2000 rpm, 2×30 seconds at 2500 rpm, 4 times 30 seconds at 3500 rpm, sample 2-6) were applied. It is estimated that the temperature in the speedmixer reaches about 60-65 °C at these settings. The disintegration of the aramid was controlled by microscopy. Under these conditions, aramid solutions could be manufactured within 4 to 12 minutes.

Table 4 shows the respective reaction conditions, the reaction time and further notes on the disintegration of the para-aramid material.

TABLE 4
High speed dissolution of para-aramid

| | | | | | Comment (condition of |
|---|---|---|---|---|---|
| | Aramid | KOH | Temperature | Reaction time | solution at end of |
| sample | source | (M) | (°C) | (minutes) | reaction) |
| 2-1 | Short | 1.0 | 60 | 10 | Fibers not anymore |
| | cut | | | | visible, but KOH |
| | | | | | crystals remain present |
| 2-2 | Short | 0.5 | 60 | 10 | Fibers not anymore |
| | cut | | | | visible, but fewer KOH |
| | | | | | crystals remain present |
| 2-3 | Short | 0.28 | 60 | 6 | No fibers and no KOH |
| | cut | | | | crystals are visible |
| 2-4 | Short | 0.28 | 40 | 12 | No fibers and no KOH |
| | cut | | | | crystals are visible |
| 2-5 | powder | 0.28 | 60-65 °C | 4 | No fibers and no KOH |
| | | | | | crystals are visible |
| 2-6 | Powder | 0.28 | 60-65 °C | 3.45 | No fibers and no KOH |
| | | | | | crystals are visible |

### Example 3-Comparison

0.2 or 3 g of poly(para-phenylene terephthalamide) (PPTA) short cut fiber was weighed on a balance and added to a glass vessel. Subsequently, 100 ml of DMSO was added, and the slurry was stirred in a mechanical stirrer at 400 rpm to result in the aramid solvent mixture.

In a separate Erlenmeyer 0.1 or 3 g of KOH was dissolved in 4 g demineralized water. This base solution was gently added drop-wise into the aramid solvent mixture. Stirring was continued until the yellow fiber has visually disappeared. In this way, samples 3-1 and 3-3 were prepared.

Alternatively, the same base solution was added drop-wise to 100 ml of DMSO and subsequently, the indicated amount of short cut fiber was added to the DMSO/KOH/water system and then stirred. In this way, comparative samples 3-2 and 3-4 were prepared. Of the obtained solutions, samples were taken, a liquid drop was examined under a light microscope to observe whether there is still microscopically visible fibrous material present and the turbidity was determined.

Table 5 shows the results. At lower para-aramid concentration, the method according to the invention (3-1) results in a lower turbidity of the solution, i.e. the solution is clearer and contains less particles than the comparative solution (3-2). At higher concentrations, the turbidity could not be determined but the solution according to the invention (3-3) has no visible fiber remnants, which in contrast are present in the comparative solution of sample 3-4.

TABLE 5
Solution properties

| | | | Base/amide | | |
|---|---|---|---|---|---|
| | PPTA conc. | KOH | ratio | Turbidity | |
| Sample | (m/v %) | (g) | (mol/mol) | (NTU) | observations |
| 3-1 (inv.) | 0.2 | 0.1 | 1.1 | 2.3 | Good dissolution |
| 3-2 (comp.) | 0.2 | 0.1 | 1.1 | 12.2 | Dissolution of fibers after |
| | | | | | initial delay |
| 3-3 (inv.) | 3.0 | 4.23 | 3.0 | n.d. | No fibers visible after 3 |
| | | | | | hours stirring |
| 3-4 (comp.) | 3.0 | 4.23 | 3.0 | n.d. | Fibers not completely |
| | | | | | dissolved after 3 hours |
| | | | | | stirring, fibers remain |
| | | | | | visible |

n.d.: too high to be possible to be determined

### Example 4—Large Scale Processing

To test the inventive process on large scale, the process was tested as a continuous process in a twin screw extruder.

PPTA powder was added into the twin screw extruder Theysohn TSK 20/40D at the first inlet position. Subsequently at an inlet position approximately at a quarter of the length of the extruder, DMSO was added with a throughput of 1120 g/hr. Further downstream, approximately at half the length of the extruder, the base solution of KOH and water was added to the aramid solvent mixture present at this point in the extruder. The weight ratio between proton donor (water) and solvent (DMSO) was 1:25. The molar ratio KOH/amide bond was 1. At the inlet position of the PPTA powder, the extruder temperature was set to 20 °C, the remaining zones in the extruder were heated to 60 °C. In the first experiment, the final PPTA concentration in the aramid solution was 5 wt %.

After a few minutes, an aramid solution was obtained where the PPTA had undergone complete disintegration and no PPTA or KOH particles were visible in microscopic analysis. Subsequently, the PPTA concentration was increased to 6 wt % and 7 wt %, the KOH concentration was accordingly increased to still result in a molar ratio KOH/amide bond of 1, with the other settings remaining the same. Also for these runs, aramid solutions were obtained after a few minutes where the PPTA had undergone complete disintegration and no PPTA or KOH particles were visible by microscopic analysis.

The aramid solution with a PPTA concentration of 6 wt % was spun through a spinneret with 6 holes of 125 μm diameter in the same way as described for example 1 with a degree of drawing of 2. The mechanical properties of the filaments were determined. The results are shown in Table 6.

TABLE 6
mechanical properties of the filaments

| Sample | LD (dtex) | BT (mN/tex) | EAB (%) | ToaR (J/g) |
|---|---|---|---|---|
| 4-1 | 5.4 | 244 | 39 | 71 |

LD = linear density,
BT = breaking tenacity,
EAB = elongation at break,
ToaR = toughness

This example demonstrates that the process according to the invention is suitable for industrial-scale production and to obtain highly concentrated aramid solutions which can be spun to obtain para-aramid yarns with attractive mechanical properties.

1. A process for manufacturing an aramid solution by combining components comprising a base, a proton donor, aramid and an aprotic solvent, wherein:
the base is dissolved in the proton donor to obtain a base solution,
the aprotic solvent and the aramid are combined to obtain an aramid-solvent mixture,
the base solution and the aramid-solvent mixture are combined to obtain a suspension, and
the suspension is mixed to obtain the aramid solution.

2. The process according to claim 1, wherein the weight ratio between the proton donor and the solvent is in the range of 1:5 to 1:1000.

3. The process according to claim 1, wherein the molar ratio of base to amide bond in the aramid is in the range of 10:1 to 1:10.

4. The process according to claim 1, wherein the aramid concentration in the aramid solution is in the range of 1 to 20 wt %.

5. The process according to claim 1, wherein the proton donor is selected from water and alcohol.

6. The process according to claim 1, wherein at least the mixing takes place in a twin shaft kneader or a twin screw extruder.

7. A process to manufacture a continuous aramid fiber, comprising:
i) providing the aramid solution produced according to the process of claim 1,
ii) passing the solution through a spinneret,
iii) coagulating the solution to result in a fiber, and
iv) washing the fiber.

8. A continuous para-aramid fiber having an elongation at break of at least 15% and a toughness at rupture of at least 40 J/g, determined according to ASTM D3822-14.

9. The continuous para-aramid fiber of claim 8 being a multifilament yarn.

10. The continuous para-aramid fiber of claim 8 having a breaking tenacity of at least 150 mN/tex, determined according to ASTM D3822-14.

11. The continuous para-aramid fiber of claim 8 having an elongation at break of at least 20%, determined according to ASTM D3822-14.

12. The continuous para-aramid fiber of claim 8 having an oriented crystallite fraction of less than 40%.

13. The continuous para-aramid fiber of claim 8 having an orientation parameter in the range of 40 to 60°.

14. The continuous para-aramid fiber of claim 8 having a relative viscosity ηᵣₑₗ in the range of 3 to 8 as determined with a viscometer.

15. The continuous para-aramid fiber of claim 8 being manufactured by a process comprising:
i) providing an aramid solution manufactured by combining components comprising a base, a proton donor, aramid and an aprotic solvent, wherein:
the base is dissolved in the proton donor to obtain a base solution,
the aprotic solvent and the aramid are combined to obtain an aramid-solvent mixture,
the base solution and the aramid-solvent mixture are combined to obtain a suspension, and
the suspension is mixed to obtain the aramid solution
ii) passing the solution through a spinneret,
iii) coagulating the solution to result in a fiber, and
iv) washing the fiber.

16. A process to manufacture aramid nanofiber, comprising:
i) providing the solution produced according to the process of claim 1, and
ii) adding a further amount of a proton donor to the solution.

17. A material comprising the aramid nanofiber obtained by the process of claim 16.
